(19) United States
(12) Patent Application Publication
(10) Pub. No.: US 2013/0247628 A1
(43) Pub. Date: Sep. 26, 2013

(54) APPARATUS AND METHOD FOR TREATING ORGANIC WASTE

(71) Applicant: Daniel RIVERO SERRANO, (US)

(72) Inventor: Dong Myung Kim Lee, Gwanak-gu (KR)

(21) Appl. No.: 13/990,353

(22) PCT Filed: Feb. 22, 2011
(86) PCT No.: PCT/KR2011/001149

§ 371 Date: May 29, 2013

(30) Foreign Application Priority Data
Dec. 2, 2010 (KR) 10-2010-0121742

(51) Int. Cl. C05F 17/00; C05F 17/02

(52) U.S. Cl. CPC C05F 17/009; C05F 17/02
USPC 71/11; 422/225; 422/118; 422/202

(57) ABSTRACT

Disclosed are an apparatus and method for treating organic waste to reduce treatment costs and period, enable environmentally friendly treatment without causing bad smell or waste water, and thereby prepare an organic combust with a high quality and a liquid fertilizer with a high concentration. The apparatus includes a sealable reaction vessel including an inlet through which an organic waste and a reactive additive are injected, an outlet through which a treated substance is discharged as reactive gas, a stirrer to stir contents of the reaction vessel, and a liquid fertilizer producer to condense the reactive gas discharged from the gas outlet with a cooling solution and thereby produce a liquid fertilizer, while gradually increasing the concentration of fertilizer components of the cooling solution.

### TECHNICAL FIELD

Embodiments of the present invention relate to an apparatus and method for treating organic waste. More specifically, embodiments of the present invention relate to an apparatus and method for treating organic waste to treat inorganic waste and thereby produce organic compost and high-concentration liquid fertilizer.

### BACKGROUND ART

Organic waste such as manure, human feces and food waste has a high water content and discharges high-concentration contaminant, thus causing serious environmental pollution, such as water pollution and bad smell, when discharged or disposed of without any treatment.

Recently, a great deal of research has focused on environmentally friendly methods of treating organic waste and utilizing the same as a resource. A method for composting an organic substance using aerotropic or anaerobic microorganisms is known. Treatment using aerotropic microorganisms is a composting method in which an organic substance is decomposed by oxidation with aerotropic microorganisms and the residue is stabilized. Treatment using anaerobic microorganisms is a method for composting an organic substance through decomposition using anaerobic bacterium, which yields methane gas as a by-product.

However, these methods have disadvantages of a complicated treatment process, and the necessity of a large treatment area and of a long treatment period of one to two months. Further, these methods have disadvantages of production of waste water or bad smell due to the difficulty of complete treatment.

### DISCLOSURE OF INVENTION

### Technical Problem

It is an aspect of the present invention to provide an apparatus and method for treating organic waste to reduce treatment costs and period, enable environmentally friendly treatment without causing bad smell or waste water, and thereby prepare an organic compost with a high quality and a high concentration liquid fertilizer.

### Solution to Problem

According to a technical concept of the present invention, there is provided an apparatus for treating organic waste, including: a sealable reaction vessel including an inlet through which an organic waste and a reactive additive are injected, an outlet through which a treated substance is discharged as reactive gas; a stirrer to stir contents of the reaction vessel; and a liquid fertilizer producer to condense the reactive gas discharged from the gas outlet with a cooling solution and thereby produce a liquid fertilizer, while gradually increasing the concentration of fertilizer components of the cooling solution.

The liquid fertilizer producer may include: a cyclone condensation vessel to induce circling and ascending of the reactive gas, the cyclone condensation vessel provided at a lower side thereof with an inlet for the reactive gas and at an upper side thereof with an outlet for the remaining gas; a liquid vessel to accept a liquid flowing downward from the condensation vessel and containing a cooling solution filled therein; and a cooling solution spray to elevate a cooling solution of the liquid vessel and thus spray the cooling solution to an upper region inside the condensation vessel.

The condensation vessel may include a plurality of partition boards to divide the condensation vessel into multiple stages of upper and lower parts and thereby form a curved passage, and a plurality of carriers filled in an upper area of the partition boards to facilitate contact of the cooling solution sprayed from the top with the ascending reactive gas.

The apparatus may further include: an electric open/close valve mounted in a pipe to connect the gas outlet to the condensation vessel, to open the gas outlet, when an inner pressure of the reaction vessel reaches a predetermined reaction pressure or higher, and to close the gas outlet, when an inner pressure of the reaction vessel is less than the predetermined reaction pressure.

The apparatus may further include: a safety valve provided in the reaction vessel, to discharge the reactive gas to the outside, when the inner pressure of the reaction vessel is a predetermined safety pressure or higher.

The stirrer may further include: a rotation axis transversely passing through the inner center of the reaction vessel and having both ends rotatably supported at the center of caps; a mixing blade mounted on the rotation axis; and a driving motor mounted at the outer side of the reaction vessel to rotate the rotation axis.

The mixing blade may include: a first mixing blade which spirally extends around the rotation axis such that the first mixing blade is close to the inner surface of the reaction vessel and is supported by a plurality of support members radially extending from the rotation axis; and a plurality of second mixing blades extending from the rotation axis in a radial direction to a length shorter than the radius of the first mixing blade and having a torsion angle to stir contents, while transporting the contents in a direction opposite to the first mixing blade.

The reaction vessel may include: a cylindrical body; and a pair of caps connected to the ends of the body, respectively, and wherein an outlet is provided under one cap, to discharge waste treated in the reaction vessel by rotation of the first mixing blade.

The apparatus may further include a pre-heater to preheat the reaction vessel, wherein the pre-heater includes: a water jacket mounted on the outer surface of the reaction vessel; and a warm water boiler to circulate warm water to the water jacket.

The apparatus may further include: a base frame to support the reaction vessel, the liquid fertilizer producer and the pre-heater arranged thereunder; a vessel frame mounted on the base frame, to support the reaction vessel; and a plurality of weight sensors mounted between the vessel frame and the base frame, to sense the weight of the contents contained in the reaction vessel.

According to a technical concept of the present invention, there is provided a method for treating organic waste including: a preparation process in which organic waste having a water content of about 75 to 85% is supplied to the reaction vessel and pre-heated to 50 to 60° C. by heating under stirring; an additive supply process, in which a reactive additive containing 20 to 30% by weight of quicklime, with respect to the total weight of contents, is added to the preheated reaction vessel; after addition of the reactive additive, a reaction process, in which the reaction vessel is sealed and the contents are stirred, to induce reaction of organic waste with the reactive additive, cause heat generation and decomposition of organic substances and thereby produce an organic fertilizer, wherein the gas outlet of the reaction vessel opens and closes, thereby maintaining the inner pressure of the reaction vessel at about 2 to 2.5 kg/cm² to facilitate the reaction; and a liquid fertilizer preparation process in which the reactive gas discharged to the gas outlet is supplied to the condensation vessel, in which a cooling solution is sprayed, in the reaction process, to allow the reactive gas to be condensed by the cooling solution and thereby produce a liquid fertilizer.

The total volume of contents including organic waste and reactive additive may be adjusted to ⅔ or less of the inner volume of the reaction vessel to secure an extra area for reaction activation.

The reaction process may be carried out at an inner temperature of the reaction vessel of 90 to 100° C. for 10 to 15 minutes.

### Advantageous Effects of Invention

The present invention provides an apparatus for treating organic waste in which organic waste and a reactive additive are added to a reaction vessel and reacted with each other to treat organic waste, thus minimizing treatment costs and period of organic waste and enabling environmentally friendly treatment without causing bad smell or waste water, thereby preparing an organic compost with a high quality and a high concentration liquid fertilizer.

### BRIEF DESCRIPTION OF DRAWINGS

These and/or other aspects of the invention will become apparent and more readily appreciated from the following description of the embodiments, taken in conjunction with the accompanying drawings of which:

FIG. 1 illustrates the configuration of an apparatus for treating organic waste according to the present invention;

FIG. 2 is a sectional view illustrating the inner configuration of a reaction vessel of the apparatus for treating organic waste according to the present invention;

FIG. 3 is a sectional view taken along the line of III-III′ of FIG. 2;

FIG. 4 is a sectional view illustrating the configuration of a liquid fertilizer producer of the apparatus for treating organic waste according to the present invention; and

FIG. 5 shows reaction schemes illustrating a series of chemical changes of various substances occurring in the reaction vessel.

### MODE FOR THE INVENTION

Hereinafter, preferred embodiments of the present invention will be described in detail with reference to the accompanying drawings.

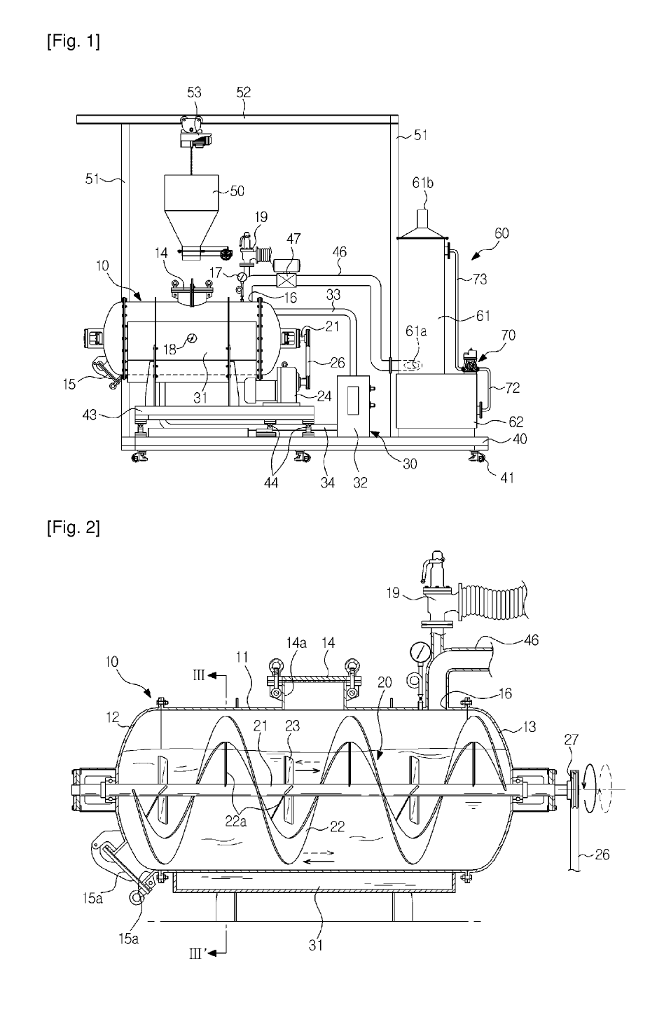

The apparatus for treating organic waste according to the present invention as shown in FIGS. 1 and 2, includes a reaction vessel 10, a stirrer 20 to stir the material contained in the reaction vessel 10, a pre-heater 30 to pre-heat the reaction vessel 10 and a liquid fertilizer producer 60 to condense a reaction gas and thus prepare a liquid fertilizer. Further, this apparatus also includes a base frame 40 to mount the reaction vessel 10, the liquid fertilizer producer 60, the pre-heater 30 and the like thereon and support the same, the base frame 40 mounted on a plurality of movable casters 41, a vessel frame 43 mounted on the base frame 40, to support the reaction vessel 10, and a movable supply hopper 50 to facilitate supply of contents to the reaction vessel 10.

The reaction vessel 10, as shown in FIG. 2, includes a cylindrical body 11 with opened both ends, and hemispherical caps 12 and 13 connected to both ends of the body 11, respectively, to close the both ends. An inlet 14 is arranged above the body 11 to supply organic waste and a reactive additive, and the inlet 14 is provided with an inlet cover 14a to seal the inlet 14. In addition, an outlet 15 is arranged under the cap 12, to discharge waste (organic compost) treated in the reaction vessel 10 and the outlet 15 is also provided with an outlet cover 15a to seal the outlet 15. The organic waste treated in the reaction vessel 10 may be manure, human feces, food waste, or the like. The reactive additive reacted with the organic waste may be quicklime, germanium, moisture additive or the like. This will be described in the illustration of the following operation and treatment method in more detail.

A gas outlet 16 to discharge the reactive gas generated in the reaction vessel 11 is provided on the body 11 of the reaction vessel 10 and a pipe 46 to guide the reactive gas to the liquid fertilizer producer 60 is connected to the gas outlet 16. In addition, the reaction vessel 10 is provided with a pressure gauge 17 to sense an inner pressure, a temperature gauge 18 to sense an inner temperature, and a safety valve 19 to automatically discharge a gas, when the inner pressure of the reaction vessel 10 increases to a predetermined safety pressure (3 kg/cm²) or higher.

The stirrer 20 includes, as shown in FIGS. 1 and 2, a rotation axis 21 transversely passing through the inner center of the reaction vessel 10 and having both ends rotatably supported at the center of caps 12 and 13, a first mixing blade 22 and a plurality of second mixing blades 23 mounted on the rotation axis 21 and a driving motor 24 mounted at the outer side of the reaction vessel 10 to rotate in a direct or reverse direction. The driving motor 24 and the rotation axis 21 are connected to each other through a belt 26 and a pully 27 to transfer power.

The first mixing blade 22 has a predetermined width and spirally extends around the rotation axis 21 such that it is close to the inner surface of the reaction vessel 10. In addition, the first mixing blade 22 is supported by a plurality of support members 22a radially extending from the rotation axis 21. In addition, the plurality of second mixing blades 23 extend from the rotation axis 21 in a radius direction to a length shorter than the radius of the first mixing blade 22, and have a torsion angle to stir contents, while transporting the contents in a direction opposite to the first mixing blade 22.

As shown in FIG. 2, the torsion angle enables the contents arranged at the center of the reaction vessel 10 to be moved in the opposite direction through the second mixing blades 23, when the contents arranged at the inner surface of the reaction vessel 10 are moved in one direction to the first mixing blade 22. When the rotation direction of the rotation axis 21 is changed, movement direction of the contents through the mixing blades 22 and 23 is also changed. In addition, when the waste treated in the apparatus is discharged, the first mixing blade 22 close to the inner surface of the reaction vessel 10 transports the inner waste of the reaction vessel 10 to the outlet 15, to facilitate the transportation.

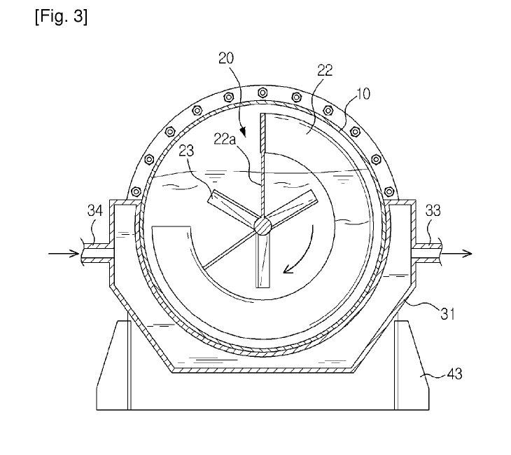

As shown in FIGS. 1 and 3, the pre-heater 30 includes a water jacket 31 mounted at a lower side and a peripheral outer surface of the reaction vessel 10 and a warm water boiler 32 to circulate warm water to the water jacket 31. As shown in FIG. 1, the warm water boiler 32 is mounted on the base frame 40 at the side of the reaction vessel 10, and the warm water boiler 32 is connected to the water jacket 31 through pipes 33 and 34. This enables warm water heated by the warm water boiler 32 to be supplied to the water jacket 31 and thus circulated, thereby heating the reaction vessel 10. Although an example in which the warm water boiler and the water jacket are used as the pre-heater 30 is illustrated, a general electric heater may be utilized.

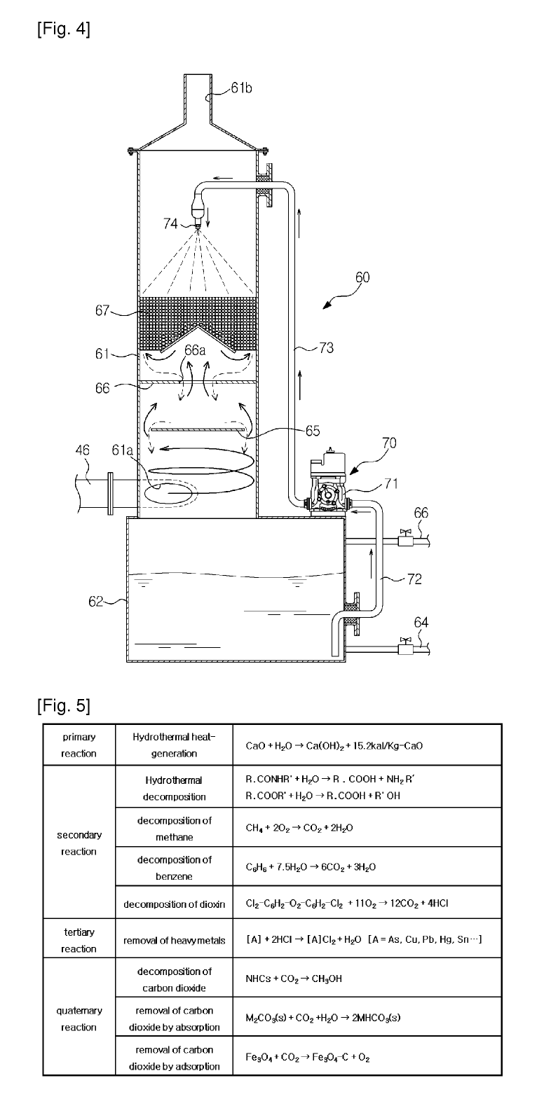

As shown in FIG. 1, a plurality of weight sensors 44 to sense the weight of the contents contained in the reaction vessel 10 are mounted between the vessel frame 43 to support the reaction vessel 10 and the base frame 40. The information detected by the weight sensor 44 is displayed through a display member of a control panel (not shown) to enable a user to confirm the information and thereby contribute to prevention of excessive supply of the contents. As shown in FIG. 4, the liquid fertilizer producer 60 to condense the discharged reactive gas and thus produce a liquid fertilizer includes a cylindrical cyclone condensation vessel 61, a liquid vessel 62 filled with a cooling solution, arranged under a condensation vessel 61 such that it supports the bottom of the condensation vessel 61, and a cooling solution spray 70 to elevate the cooling solution of the liquid vessel 62 and to spray the same to an upper area provided inside the condensation vessel 61.

The cyclone condensation vessel 61 has an opened bottom and is provided at a lower side thereof with an inlet 61a for the reactive gas and at an upper side thereof with an outlet 61b for the remaining gas. Further, to induce detour of the injected reactive gas, the condensation vessel 61 is provided at an eccentric position thereof with the inlet 61a.

As shown in FIG. 1, the inlet 61a of the condensation vessel 61 is connected to a pipe 46 which extends from the gas outlet 16 of the reaction vessel 10, to enable the reactive gas to be supplied from the reaction vessel. This pipe 46 is connected in a bent form, in order to reduce vibration and shock caused by discharge pressure of the reactive gas.

A part (top) in which the liquid vessel 62 is connected to the bottom of the condensation vessel 61 communicates with the condensation vessel 61 in order to allow injection of a liquid which flows downward from the condensation vessel 61. The liquid vessel 62 may be provided with a pipe 63 to supply a cooling solution and a pipe 64 to discharge a diluted liquid fertilizer produced by condensation of the reactive gas.

A cooling solution spray 70 includes a pump 71 to intake and deliver a cooling solution, an intake pipe 72 mounted in the liquid vessel 62 and connected to an inlet of the pump 71, a discharge pipe 73 connected to an outlet of the pump 71 and having a top present in the condensation vessel 61, and a spray nozzle 74 mounted on the end of the discharge pipe 73 in the condensation vessel 61.

The condensation vessel 61 includes a first partition board 65 and a second partition board 66 to divide the condensation vessel 61 into multiple stages of the upper and lower parts and thereby form a curved passage, and a plurality of carriers 67 filled in a upper region of the second partition board 66 to facilitate contact of the cooling solution sprayed from the top with the ascending reactive gas.

The first partition board 65 has a circular circumference spaced from the inner surface of the condensation vessel 61, and the second partition board 66 is arranged above the first partition board 65 such that it is spaced from the first partition board 65, has a center with an opening 66a and has a ring-shaped circumference connected to the inner surface of the condensation vessel 61. This enables an ascending passage of the reactive gas supplied to the condensation vessel 61 to be curved and thus lengthened, and improves condensation effect of the reactive gas by cooling water.

The carriers 67 may take the shape of a polygon or ball with a plurality of holes and may be provided with a plurality of horns protruding outward. These carriers 67 improve an opportunity to bring ascending reactive gas into gaps provided therebetween in contact with cooling water flowing downward from the top and thus enhance condensation of the reactive gas.

An electric open/close valve 47 which opens the gas outlet 16, when an inner pressure of the reaction vessel 10 reaches a predetermined reaction pressure (2 to 2.5 kg/cm²) or higher, and closes the gas outlet 16, when an inner pressure of the reaction vessel 10 is less than the predetermined reaction pressure is mounted in a pipe 46 to connect the gas outlet 16 of the reaction vessel 61 to the inlet 61a of the condensation vessel 61. This maintains the inner pressure of the reaction vessel 10 at 2 to kg/cm² during the reaction process, and thus promotes reaction and enables the reactive gas to be discharged to the condensation vessel 61, when the pressure exceeds the predetermined level. A safety valve 19 opens and discharges the reactive gas outside, when the inner pressure of the reaction vessel 10 reaches a safety pressure of about of 3 kg/cm² or higher.

As shown in FIG. 1, the movable supply hopper 50 is connected to an electric hoist 53 which moves along a rail supported by a structure 51 and mounted on the reaction vessel 10. The hoist 53 enables ascending and movement of the movable supply hopper 50 and easy supply of the reactive additive such as organic waste or quicklime to the reaction vessel 10. Although the movable supply hopper 50 is suggested as a supply medium, the supply medium is not limited thereto and may be an automatic supply system to carry organic waste or reactive additive from a storage region to the reaction vessel using a transfer pump 71 or conveyor.

A method for treating organic waste using this apparatus will be described.

The organic waste to be treated may be pig, livestock, chicken or human waste. In order to treat organic waste, first, a preparation process in which organic waste is supplied to the reaction vessel 10 and pre-heated. The supplied organic waste has a water content of about 75 to 85%, so that it can react with reactive additive injected into the reaction vessel 10.

After the organic waste is supplied to the reaction vessel 10, a stirrer 20 is operated to begin stirring of contents. The stirrer 20 repeats direct and inverse rotations at a set interval (about 1 to 2 minutes) to enable the contents to be homogeneously mixed. At the same time, the reaction vessel 10 is pre-heated to 50 to 60° C. by the pre-heater 30. The simultaneous operation of stirring and pre-heating enables organic waste in the reaction vessel 10 to be homogeneously heated and the same to reach to a temperature suitable for the reaction.

After the preparation process, an additive supply process in which quicklime, a germanium powder and a reactive additive containing a predetermined amount of water-absorbent are added to the reaction vessel 10 is performed. Quicklime is added in an amount of 20 to 30% by weight, with respect to the total weight of contents supplied to the reaction vessel 10. Further, the total volume of contents including organic waste and reactive additive is adjusted to ⅔ or less of the inner volume of the reaction vessel 10. This secures an extra area for reaction activation inside the reaction vessel 10.

After the reactive additive is added, a reaction process, in which the inlet 14 is sealed with the inlet cover 14a and the contents are stirred with the stirrer 20 to induce reaction, is performed. That is, organic waste and reactive additive are homogeneously mixed with the mixing blades 22 and 23 to perform reaction in the reaction vessel 10.

As a result, in the reaction vessel 10, quicklime reacts with organic waste to produce heat and the inner temperature of the reaction vessel increases to 90 to 100° C. In some cases, the temperature increases up to 150° C. Further, as a result of the reaction, organic waste is decomposed, water content is decreased to a level less than about 25% and the contents are transformed into a high-quality organic fertilizer. Such a reaction process is carried out for 10 to 15 minutes.

In the reaction process, organic waste undergoes variation in chemical composition and crystalline structure in the reaction vessel through sequential chemical reactions and is converted into an environmentally friendly organic fertilizer. That is, toxic substances, such as benzene, contained in waste are separated through cleavage of molecular bond between carbon (C) and hydrogen (H). Further, toxic substances such as dioxin, chloroform, TNT and iron chloride are decomposed through a series of reactions and high-quality organic fertilizer components such as nitrogen (N), phosphorus (P), potassium (K), calcium (Ca), magnesium (Mg), sulfur (S) and chlorine (Cl) are thus produced. Further, in the reaction process, salts and bad smells are removed, parasites and pathogenic bacteria are substantially killed and properties thereof are changed to alkali beneficial for soil neutralization. FIG. 5 shows reaction schemes illustrating a series of chemical variation of substances occurring in the reaction vessel.

Further, in the reaction process, the inner pressure of the reaction vessel 10 increases since the reactive gas containing steam and a particle powder is formed. The open/close valve 47 opens the gas outlet 16 to discharge the reactive gas to the liquid fertilizer producer 60, when the inner pressure increases to 2 kg/cm² or higher. The open/close valve 47 automatically opens and closes the gas outlet 16, depending on variation in the pressure of the reaction vessel 10 and thereby maintains the inner pressure of the reaction vessel 10 at about 2 to 2.5 kg/cm². Maintaining the inner pressure at 2 to 2.5 kg/cm² provides conditions beneficial for reaction to the reaction vessel 10 and promotes reactions.

In addition to the reaction processes, a liquid fertilizer preparation process in which the liquid fertilizer producer 60 condenses the reactive gas discharged to the gas outlet 16 and produces a liquid fertilizer is carried out. At this time, the reactive gas containing water and a particle powder is injected into the bottom of the condensation vessel 61, circulates in the condensation vessel 61, passes through the area provided between the partition boards 65 and 66 and ascends through the gaps between the carriers 67. At the same time, the cooling solution accepted in the liquid vessel 62 is sprayed above the condensation vessel 61 through the cooling solution spray 70. Accordingly, ascending reactive gas comes into contact with the cooling solution which is sprayed and flows downward to condense reactive gas, and the condensed liquid flows together with the cooling solution and is accumulated in the liquid vessel 62.

A condensed high-concentration fertilizer component flows downward and is thus mixed with the cooling solution accepted in the liquid vessel 62 to produce a liquid fertilizer and the concentration thereof increases, as the reaction proceeds. That is, such treatment is repeated to convert the cooling solution into a high-concentration liquid fertilizer.

The content, that is, organic compost treated in the reaction vessel 10 can be discharged by operating the stirrer 20, while opening the outlet 15. This discharge is carried out by the first mixing blade 22 which pushes the contents toward the outlet 15. The discharged organic compost may be used as a soil conditioner, without any treatment.

Although a few embodiments of the present invention have been shown and described in conjunction with accompanying drawings, it is clearly understood that the foregoing embodiments do not particularly restrict the scope of the present invention. Accordingly, it would be appreciated by those skilled in the art that various substitutions, variations and/or modifications may be made in these embodiments without departing from the principles and spirit of the invention.

1. An apparatus for treating organic waste, comprising:
a sealable reaction vessel including an inlet through which an organic waste and a reactive additive are injected, an outlet through which a treated substance is discharged as reactive gas;
a stirrer to stir contents of the reaction vessel; and
a liquid fertilizer producer to condense the reactive gas discharged from the gas outlet with a cooling solution and thereby produce a liquid fertilizer, while gradually increasing the concentration of fertilizer components of the cooling solution.

2. The apparatus according to claim 1, wherein the liquid fertilizer producer comprises:
a cyclone condensation vessel to induce circling and ascending of the reactive gas, the cyclone condensation vessel provided at a lower side thereof with an inlet for the reactive gas and at an upper side thereof with an outlet for the remaining gas;
a liquid vessel to accept a liquid flowing downward from the condensation vessel and containing a cooling solution filled therein; and
a cooling solution spray to elevate a cooling solution of the liquid vessel and thus spray the cooling solution to an upper region inside the condensation vessel.

3. The apparatus according to claim 2, wherein the condensation vessel comprises a plurality of partition boards to divide the condensation vessel into multiple stages of upper and lower parts and thereby form a curved passage, and a plurality of carriers filled in a upper area of the partition boards to facilitate contact of the cooling solution sprayed from the top with the ascending reactive gas.

4. The apparatus according to claim 2, further comprising:
an electric open/close valve mounted in a pipe to connect the gas outlet to the condensation vessel, to open the gas outlet, when an inner pressure of the reaction vessel reaches a predetermined reaction pressure or higher, and to close the gas outlet, when an inner pressure of the reaction vessel is less than the predetermined reaction pressure.

5. The apparatus according to claim 4, further comprising:
a safety valve provided in the reaction vessel, to discharge the reactive gas to the outside, when the inner pressure of the reaction vessel is a predetermined safety pressure or higher.

6. The apparatus according to claim 1, wherein the stirrer comprises:
a rotation axis transversely passing through the inner center of the reaction vessel and having both ends rotatably supported at the center of caps;
a mixing blade mounted on the rotation axis; and
a driving motor mounted at the outer side of the reaction vessel to rotate the rotation axis.

7. The apparatus according to claim 6, wherein the mixing blade comprises:
a first mixing blade which spirally extends around the rotation axis such that the first mixing blade is close to the inner surface of the reaction vessel and is supported by a plurality of support members radially extending from the rotation axis; and
a plurality of second mixing blades extending from the rotation axis in a radial direction to a length shorter than the radius of the first mixing blade and having a torsion angle to stir contents, while transporting the contents in a direction opposite to the first mixing blade.

8. The apparatus according to claim 7, wherein the reaction vessel comprises:
a cylindrical body; and
a pair of caps connected to the ends of the body, respectively, and wherein an outlet is provided under one cap, to discharge waste treated in the reaction vessel by rotation of the first mixing blade.

9. The apparatus according to claim 1, further comprising:
a pre-heater to preheat the reaction vessel,
wherein the pre-heater comprises:
a water jacket mounted on the outer surface of the reaction vessel; and
a warm water boiler to circulate warm water to the water jacket.

10. The apparatus according to claim 1, further comprising:
a base frame to support the reaction vessel, the liquid fertilizer producer and the pre-heater arranged thereunder;
a vessel frame mounted on the base frame, to support the reaction vessel; and
a plurality of weight sensors mounted between the vessel frame and the base frame, to sense the weight of the contents contained in the reaction vessel.

11. A method for treating organic waste comprising:
a preparation process in which organic waste having a water content of about 75 to 85% is supplied to the reaction vessel and pre-heated to 50 to 60° C. by heating under stirring;
an additive supply process, in which a reactive additive containing 20 to 30% by weight of quicklime, with respect to the total weight of contents, is added to the preheated reaction vessel;
after addition of the reactive additive, a reaction process, in which the reaction vessel is sealed and the contents are stirred, to induce reaction of organic waste with the reactive additive, cause heat generation and decomposition of organic substances and thereby produce an organic fertilizer, wherein the gas outlet of the reaction vessel opens and closes, thereby maintaining the inner pressure of the reaction vessel at about 2 to 2.5 kg/cm² to facilitate the reaction; and
a liquid fertilizer preparation process in which the reactive gas discharged to the gas outlet is supplied to the condensation vessel, in which a cooling solution is sprayed, in the reaction process, to allow the reactive gas to be condensed by the cooling solution and thereby produce a liquid fertilizer.

12. The method according to claim 11, wherein the total volume of contents including organic waste and reactive additive is adjusted to ⅔ or less of the inner volume of the reaction vessel to secure an extra area for reaction activation.

13. The method according to claim 11, wherein the reaction process is carried out at an inner temperature of the reaction vessel of 90 to 100° C. for 10 to 15 minutes.
